(19) United States
(12) Patent Application Publication
(10) Pub. No.: US 2018/0345754 A1
(43) Pub. Date: Dec. 6, 2018

(54) HEAT EXCHANGER

(71) Applicant: Mahle International GmbH, Stuttgart (DE)

(72) Inventors: Juergen Gruenwald, Ludwigsburg (DE); Christian Heneka, Karlsruhe (DE)

(73) Assignee: Mahle International GmbH, Stuttgart (DE)

(21) Appl. No.: 15/781,127

(22) PCT Filed: Nov. 30, 2016
(86) PCT No.: PCT/EP2016/079302

§ 371 Date: Jun. 2, 2018

(30) Foreign Application Priority Data
Dec. 2, 2015 (DE) 10 2015 224 082.7

(51) Int. Cl. B60H 1/00; F24H 3/04; F24H 3/12

(52) U.S. Cl. CPC B60H 1/00328; B60H 1/00478; F28D 2021/0096; F24H 3/12; F24H 3/0429

(57) ABSTRACT

A heat exchanger for heating a vehicle interior may include a heat exchanger block including a plurality of air ducts and a plurality of coolant ducts arranged according to a cross flow principle. The heat exchanger block may have a first heat exchanger stage including an air inlet side and a second heat exchanger stage including an air outlet side. The plurality of air ducts and the plurality of coolant ducts may extend through the heat exchanger block and may be coupled to one another in a heat-transferring and media-separated manner in both the first heat exchanger stage and the second heat exchanger stage. The heat exchanger may further include a plurality of thermoelectric modules, configured to operate as a heat pump to transfer heat from the coolant flow to the air flow, arranged between the plurality of air ducts and the plurality of coolant ducts.

### CROSS-REFERENCE TO RELATED APPLICATIONS

This application claims priority to International Patent Application No. PCT/EP2016/079302, filed on Nov. 30, 2016, and German Patent Application No. DE 10 2015 224 082.7, filed on Dec. 2, 2015, the contents of both of which are hereby incorporated by reference in their entirety.

### TECHNICAL FIELD

The present invention relates to a heat exchanger, in particular a heat exchanger for heating a vehicle interior via a cooling circuit of a vehicle comprising electric or hybrid drive. The invention also relates to a vehicle, which is equipped with at least one such heat exchanger.

### BACKGROUND

In vehicles comprising electric drive or hybrid drive, it may also be necessary, in particular in the case of low ambient temperatures, to heat the vehicle interior. At least electrical energy is available for this purpose, for example to be able to operate an electrical heating device. Such an electrical heating of the vehicle interior, however, has a highly disadvantageous effect on the range of the vehicle in the electric driving mode. On principle, a vehicle comprising electric drive or hybrid drive also has components, which heat up during operation of the vehicle and which may need to be cooled. For example, a vehicle battery, a power electronics as well as electric drive motors can heat up in the electric drive mode. Heat generated thereby can be used to heat the vehicle interior. If provision is made for a hybrid drive comprising an internal combustion engine, the internal combustion engine generates exhaust heat, which can be used to heat the vehicle interior, in the combustion drive mode.

In the case of vehicles comprising combustion engines as drive, it is common to provide a heat exchanger, which is integrated into an engine cooling circuit, and an electrically operated heater, which is always turned on, when the heat, which is available via the cooling circuit, is not sufficient to heat the vehicle interior to the desired extent, in order to heat the vehicle interior.

A room air conditioner, with the help of which an air flow can be heated, which, in turn, serves to heat a living area, is known from WO 2012/110461 A1. The heat required for this purpose is provided via a fluid flow. The room air conditioner has two heat exchangers, which are arranged downstream from one another and which each have an air duct, through which the air flow can flow, in their respective heat exchanger block, and a heating medium duct, through which the heating medium can flow, which are coupled to one another in a heat-transferring and in a media-separated manner. The air duct and the heating medium duct are thereby arranged in the respective heat exchanger block according to the co-flow principle. Due to the two heat exchangers, the room air conditioner has a two-stage heating of the air flow. A Peltier element, with the help of which heat can be pumped from the liquid heating medium flow to the air flow or vice versa, is arranged in the second heat exchanger, which is assigned to the subsequent heating stage.

A hybrid air conditioning system is known from DE 697 22 206 T2, which is also provided for a use on a building. Two separate air-air heat exchangers, through which an air flow, which is to be cooled, flows in series, are arranged in a housing. A first cooling air flow also flows through the heat exchanger, which is arranged upstream and which is flown through first, so that a pre-cooling of the air flow to be cooled can be attained via the first heat exchanger. A further cool-down in connection with a second cooling air flow as well as in connection with thermoelectric converters, which are integrated into the second heat exchanger, occurs in the subsequent second heat exchanger, which is arranged downstream.

A cooling system for electrical devices, such as, for example a computer, is known from U.S. Pat. No. 6,705,089 B2, which has two separate cooling devices, which are arranged in series in a cooling circuit. The first cooling device, which is arranged upstream in the cooling circuit, is thereby provided to cool down the coolant, which circulates in the cooling circuit, to ambient temperature. In contrast thereto, the second cooling device, which is arranged upstream thereof in the cooling circuit, serves the purpose of cooling down the coolant to below the ambient temperature, before it is then supplied to the respective electrical component, which is to be cooled. The second cooling device is equipped with electrothermal converters in order to improve the cooling effect for the coolant.

### SUMMARY

The present invention deals with the problem of specifying an improved embodiment for a heat exchanger of the above-mentioned type or for a vehicle equipped therewith, respectively, which is in particular characterized by a small installation space requirement as well as by a high operating comfort, even if the available heat varies strongly.

According to the invention, this problem is solved by the subject matter of the independent claim(s). Advantageous embodiments are the subject matter of the dependent claim(s).

The invention is based on the general idea of embodying two heat exchanger stages, which are arranged downstream from one another with respect to the air flow, in the heat exchanger block of the heat exchanger. The embodiment of two heat exchanger stages in one and the same heat exchanger block leads to a particularly compact design for the heat exchanger. This design further also has the result that a first heat exchanger stage has the air inlet side of the heat exchanger block, while a second heat exchanger stage has an air outlet side of the heat exchanger block. In this respect, the two heat exchanger stages are arranged downstream from one another in terms of the air flow in such a way that the air flow flows through the first heat exchanger stage first, while the air flow flows through the second heat exchanger stage afterwards. Provision is furthermore made in the joint heat exchanger block for a plurality of air ducts, through which the air flow can flow, and for a plurality of coolant ducts, through which a coolant flow can flow, and they are arranged in such a way that they are guided through both heat exchanger stages and are coupled to one another in a heat-exchanging and media-separated manner in both heat exchanger stages. The compact design is also supported in that the arrangement of air ducts and coolant ducts in the heat exchanger block occurs in such a way that the coolant and the air flows through the heat exchanger as a whole during operation and through the two heat exchanger stages individually according to the cross flow principle. Provision is furthermore made in the case of the heat exchanger according to the invention to arrange a plurality of thermoelectric modules between the air ducts and the coolant ducts in only one of the two heat exchanger stages. Such thermoelectric modules or converters can convert electric power into heat and have so-called Peltier elements. The thermoelectric modules can be operated as heat pump, depending on need, to transfer heat from the coolant flow to the air flow or vice versa. The integration of the thermoelectric modules into only one of the two stages of the heat exchanger results in a particularly advantageous design. The thermoelectric modules are preferably arranged exclusively in the second heat exchanger stage. On principle, however, an embodiment is also conceivable, in which the thermoelectric modules are arranged exclusively in the first heat exchanger stage. The accommodation of the thermoelectric modules only in the one or second heat exchanger stage, respectively, has the advantage that a direct heat coupling between air ducts and coolant ducts in the other or first heat exchanger stage, respectively, can be used for an efficient heat transfer, while the heat pump function of the thermoelectric modules can be used in the second heat exchanger stage depending on need. Compared to a heat exchanger, which has only a single heat exchanger stage, which is equipped with thermoelectric converters, a significantly improved heat transfer results for the case that the thermoelectric converters are not active, because the deactivated thermoelectric converters quasi act as thermal insulators.

According to an advantageous embodiment, the first heat exchanger stage and the second heat exchanger stage can adjoin one another in a depth direction of the heat exchanger block. At least two such coolant ducts can now run parallel to one another in the heat exchanger block and can be arranged downstream from one another or next to one another, respectively, in the depth direction. A plurality of such coolant ducts can furthermore run parallel to one another in the heat exchanger block and can be arranged on top of one another or next to one another, respectively, in a height direction of the heat exchanger block, which runs perpendicular to the depth direction. The air ducts are embodied between coolant ducts, which are adjacent to one another in the height direction, in the heat exchanger block. The air ducts and the coolant ducts thus penetrate one another in a projection parallel to the height direction according to the cross flow principle.

In an advantageous further development, the air ducts can extend continuously from the air inlet side to the air outlet side, wherein the respective continuous air duct has a duct height measured in the height direction, which is substantially constant along the depth direction and/or which is approximately identical in the first heat exchanger stage and in the second heat exchanger stage. A cross-sectional jump, which leads to an increased flow resistance, is thus avoided within the respective air duct. The totality of all air ducts defines an air path, which leads through the heat exchanger block or through the heat exchanger, respectively. Advantageously, this air path in the first heat exchanger stage and in the second heat exchanger stage now has approximately the same cross section, through which the air flow can flow.

In another advantageous further development, an arrangement of at least one such thermoelectric module and a coolant duct can be arranged in the second heat exchanger stage between two air ducts, which are adjacent in the height direction. This results in a particularly compact design.

On principle, provision can be made in a cost-efficient embodiment for the arrangement to only have a single one such thermoelectric module and the coolant duct. The respective air duct is then coupled only to one of the adjacent coolant ducts via this thermoelectric module.

In the alternative, an embodiment is preferred, in which the arrangement has two such thermoelectric modules and the coolant duct, which is arranged in the height direction between these two thermoelectric modules. A layer structure, in the case of which an air duct is followed by a thermoelectric module, which is followed by a coolant duct, which is followed by a further thermoelectric module and only the latter is followed by a further air duct, thus results in the height direction.

In a further development, the respective arrangement can have an arrangement height, which is measured in the height direction and which is approximately as large as a duct height, which is measured in the height direction, of a coolant duct, which runs in the first heat exchanger stage and which is adjacent to this arrangement in the depth direction. It is attained through this that approximately the same installation space in the height direction is required in the area of the coolant ducts within the first heat exchanger stage and within the second heat exchanger stage. In other words, the duct height of a coolant duct in the first heat exchanger stage corresponds to the sum of duct height of a coolant duct in the second heat exchanger stage and twice the height of such a thermoelectric module. If the coolant ducts in both heat exchanger stages have approximately the same dimensions in the depth direction, the cross section in the coolant ducts, through which the coolant flow can flow, is thus larger in the first heat exchanger stage than in the second heat exchanger stage.

In another advantageous embodiment, the coolant ducts can extend straight and parallel to one another as well as parallel to a width direction of the heat exchanger block, which runs perpendicular to the height direction and perpendicular to the depth direction. A particularly simple setup, which can be realized in a cost-efficient manner, thus results for the heat exchanger block.

In another embodiment, the coolant ducts can be formed by coolant flow-guiding coolant pipes, which run in the heat exchanger block. A further development is then particularly advantageous, in which the air ducts in the first heat exchanger stage are limited by the coolant pipes and in the second heat exchanger stage by the thermoelectric modules. The limitation of the air ducts by the coolant pipes or by the thermoelectric modules, respectively, thereby occurs in the height direction. A particularly cost-efficient setup for the heat exchanger results through this.

In another embodiment, the coolant ducts can be fluidically connected to one another in such a way in the heat exchanger block that the coolant flow can flow through the coolant ducts, which run in the first heat exchanger stage, and through the coolant ducts, which run in the second heat exchanger stage, in parallel. The heat exchanger thus has a particularly low flow resistance for the coolant flow.

According to a further development, provision can be made on the heat exchanger block for a distributor box, which is shared by the first heat exchanger stage and the second heat exchanger stage, comprising a coolant inlet, and a header box, which is shared by the first heat exchanger stage and the second heat exchanger stage, comprising a coolant outlet, which are arranged on sides of the heat exchanger block, which face away from one another in a width direction of the heat exchanger block and which are fluidically connected to one another via the coolant ducts. The width direction of the heat exchanger block thereby extends perpendicular to the height direction thereof and perpendicular to the depth direction thereof.

In an alternative embodiment, the coolant ducts can be fluidically connected to one another in such a way in the heat exchanger block that the coolant flow can flow through the coolant ducts, which run in the first heat exchanger stage, and through the coolant ducts, which run in the second heat exchanger stage, in series. In this embodiment, a particularly efficient heat transfer can be realized between coolant flow and air flow.

A further development is advantageous here, in the case of which a distributor box, which is assigned to the one heat exchanger stage, comprising a coolant inlet and a header box, which is assigned to the other heat exchanger stage, comprising a coolant outlet, are arranged on a first side, while a deflection box, which is fluidically connected to the distributor box and to the header box via the coolant ducts, is arranged on a second side of the heat exchanger block, which faces away from the first side in a width direction of the heat exchanger block. As mentioned, the width direction extends perpendicular to the height direction and perpendicular to the depth direction.

The heat exchanger in the case of the last-mentioned embodiments can be embodied particularly advantageously in such a way that it operates according to the cross co-flow principle. In this case, the coolant flow crosses or traverses, respectively, the air flow, whereby the coolant flow also runs in co-flow with respect to the air flow from the first heat exchanger stage to the second heat exchanger stage, thus first flows through the first heat exchanger stage and then through the second heat exchanger stage, like the air flow.

A vehicle according to the invention, which is equipped with an electric drive or with a hybrid drive and which is preferably a road vehicle, has a cooling circuit, in which a coolant circulates, and which serves to cool at least one component of the vehicle, which heats up during operation of the vehicle. A heat exchanger of the above-described type is installed into the cooling circuit in such a way that the coolant of the cooling circuit can flow through the coolant ducts of the heat exchanger. The vehicle is further equipped with a fan for generating an air flow, which is guided through the air ducts of the heat exchanger and into a vehicle interior. Provision is additionally made for a control device, by means of which the thermoelectric modules of the heat exchanger can be controlled in such a way that they work as heat pump. The control device is furthermore programmed or designed in such a way, respectively, that it switches on the thermoelectric modules more or less strongly for heating the air flow as a function of the temperature of the coolant and as a function of a deviation or difference of setpoint temperature and actual temperature of the vehicle interior. If the temperature of the coolant is sufficiently high, a heating of the air flow even without switching on the thermoelectric modules may be sufficient. When cold-starting the vehicle, in contrast, it may be necessary to heat the air flow exclusively via the thermoelectric modules. Likewise, quasi any number of mixed operating states is possible, in the case of which the control device energizes the thermoelectric modules more or less strongly, in order to obtain a combination of passively transferred coolant heat flow, actively pumped coolant heat flow and electric heating power in each case. Such an actively pumped coolant heat flow is provided by the heat pump effect of the thermoelectric modules, which is present more strongly or more weakly in response to the energizing of the thermoelectric modules as a function of the current boundary conditions.

Further important features and advantages of the invention follow from the subclaims, from the drawings, and from the corresponding figure description by means of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the description below, whereby identical reference numerals refer to identical or similar or functionally identical components.

### BRIEF DESCRIPTION OF THE DRAWINGS

In each case schematically,

FIG. 1 shows a highly simplified, circuit diagrammatic schematic diagram of a vehicle comprising a hybrid drive, which is equipped with a heat exchanger,

FIG. 2 shows a highly simplified longitudinal section of the heat exchanger,

FIGS. 3 and 4 in each case show a longitudinal section of the heat exchanger as in FIG. 2, but in a sectional plane, which is rotated by 90°, as well as in two different embodiments.

### DETAILED DESCRIPTION

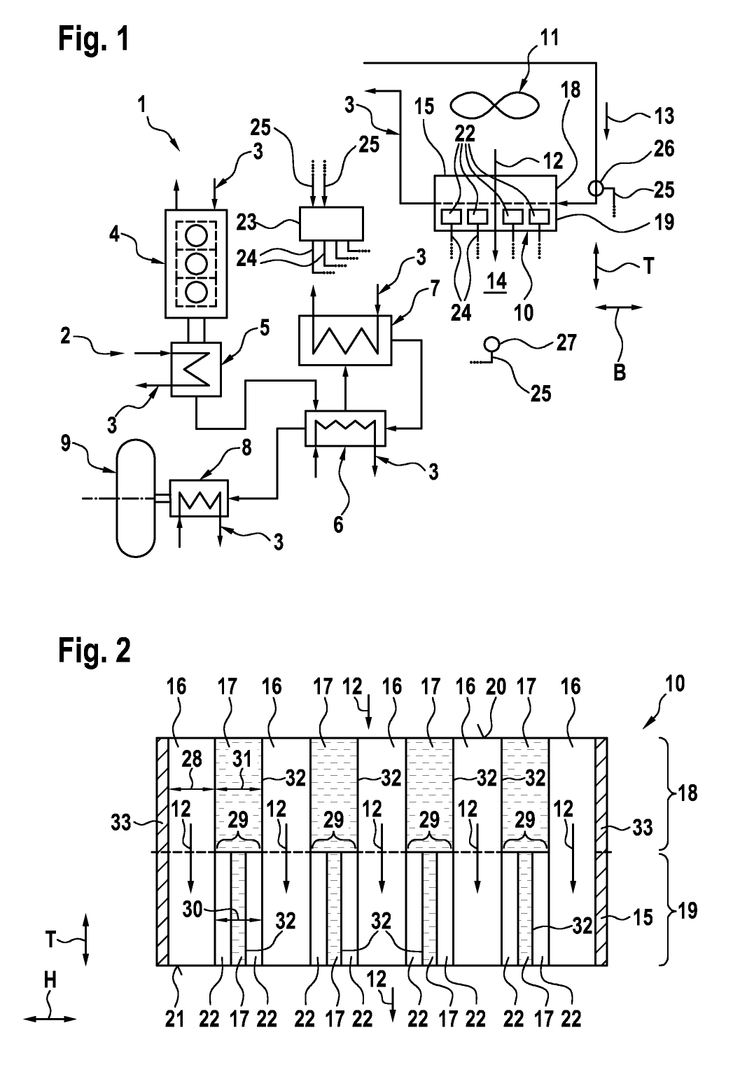

According to FIG. 1, a vehicle 1 comprises a hybrid drive 2 comprising at least one cooling circuit 3 for cooling at least one component of the vehicle 1. In the shown example, the hybrid drive 2 is embodied as serial hybrid, in the case of which an internal combustion engine 4 drives a module 5, which charges a battery 7 via a power electronics 6. The drive of the vehicle 1 occurs only electrically via at least one electric motor 8, which is supplied with power by the battery 7, and which is connected to at least one drive wheel 9 of the vehicle 1 in a suitable manner. The power electronics 6 controls the power supply of the electric motor 8 and the charging of the battery 7. Each of the mentioned components can heat up during the operation of the vehicle 1. It is common thereby to connect the internal combustion engine 4 to a cooling circuit 3. The module 5 can also be connected to a cooling circuit 3. The battery 7, the power electronics 6, and the respective electric motor 8 can likewise also each be connected to a cooling circuit 3. On principle, different cooling circuits 3 can be used here. They can likewise be different circuits or sections of a joint cooling circuit 3. In any event, a heat exchanger 10 is integrated into at least one such cooling circuit 3, so that coolant, which circulates in the cooling circuit 3, can also flow through the heat exchanger 10. The vehicle 1 is further equipped with a fan 11, with the help of which an air flow 12 can be generated, which is also guided through the heat exchanger 10. A heat-transferring coupling between the air flow 12 and a coolant flow 13 occurs in the heat exchanger 10. The air flow 12 is supplied to a vehicle interior 14, in order to heat the latter as needed.

In another embodiment, the hybrid drive 2 can also be embodied as parallel hybrid or as power-split mixed hybrid or as mixed hybrid, respectively.

According to FIGS. 1 to 4, the heat exchanger 10 has a heat exchanger block 15, which has a plurality of air ducts 16, through which the air flow 12 can flow in parallel, and a plurality of coolant ducts 17, through which the coolant flow 13 can flow. The air ducts 16 and the coolant ducts 17 are coupled to one another in a heat-transferring and media-separated manner in the heat exchanger block 15, so that an efficient heat transfer occurs between coolant flow 13 and air flow 12, while no mixing of air and coolant occurs.

According to FIGS. 1, 3 and 4, the air ducts 16 and the coolant ducts 17 are arranged in the heat exchanger block 15 according to the cross flow principle. The heat exchanger 10 or its heat exchanger block 15, respectively, has a depth direction T, which is defined by the flow-through direction, with which the air flow 12 flows through the heat exchanger block 15, a height direction H, which runs perpendicular to the depth direction T and which can be seen in FIG. 2, as well as a width direction B, which runs perpendicular to the depth direction T and perpendicular to the height direction H and which can be seen in FIGS. 1, 3 and 4. The air flow 12 flows through the heat exchanger block 15 in the depth direction T, while the coolant flow 13 flows through the heat exchanger block 15 substantially parallel to the width direction B. The flow paths of air flow 12 and coolant flow 13 thus cross one another in the heat exchanger block 15, whereby the cross flow principle is realized.

The heat exchanger 10 introduced here has a first heat exchanger stage 18 and a second heat exchanger stage 19 within the one heat exchanger block 15. While an air inlet side 20 of the heat exchanger block 15 is assigned to the first heat exchanger stage 18, an air outlet side 21 of the heat exchanger block 15 is assigned to the second heat exchanger stage 19. The air flow 12 thus flows through the first heat exchanger stage 18 and then through the second heat exchanger stage 19. The air ducts 16 and the coolant ducts 17 are installed in such a way in the heat exchanger block 15 that they are guided through the first heat exchanger stage 18 as well as through the second heat exchanger stage 19, namely in such a way that the air ducts 16 and the coolant ducts 17 are coupled to one another in a heat-transferring and media-separated manner in the first heat exchanger stage 18 as well as in the second heat exchanger stage 19. In other words, a heat transfer between coolant flow 13 and air flow 12 occurs in the first heat exchanger stage 18 as well as in the second heat exchanger stage 19, which is attained by means of a corresponding installation of the air ducts 16 and of the coolant ducts 17.

In the second heat exchanger stage 19, a plurality of thermoelectric modules 22 is also arranged in the heat exchanger block 15, namely in each case between one air duct 16 each and one coolant duct 17 each. These thermoelectric modules 22 can be operated as heat pump as needed to transfer heat from the coolant flow 13 to the air flow 12. As can be seen, the thermoelectric modules 22 are only provided in the second heat exchanger stage 19. No thermoelectric modules 22 are thus provided in the first heat exchanger stage 18.

According to FIG. 1, the vehicle 1 is equipped with a control device 23, which is electrically connected to the thermoelectric modules 22 via suitable control lines 24 so as to operate the thermoelectric modules 22. The control device 23 can furthermore be connected to temperature sensors 26, 27 via signal lines 25. The one temperature sensor 26 determines the temperature of the coolant directly upstream of the heat exchanger 10. The other temperature sensor 27 determines the actual temperature in the vehicle interior 14. The control device 23 can now be programmed or designed in such a way, respectively, that it controls or regulates, respectively, the heating of the air flow 12 as a function of a desired temperature for the vehicle interior 14, which can also be identified as setpoint temperature. It can thereby switch on the thermoelectric modules 22 more or less strongly as a function of the current temperature of the coolant and as a function of the current setpoint-actual deviation of the temperature of the vehicle interior 14.

According to FIGS. 2 to 4, the two heat exchanger stages 18, 19 are arranged downstream from one another in the depth direction T, so that they adjoin one another in the depth direction T. In the height direction H, a plurality of coolant ducts 17 are arranged on top of one another or next to one another, respectively, according to FIG. 2. In the depth direction T, at least two coolant ducts 17 are arranged downstream from one another. The coolant ducts 17 in each case extend parallel to one another. The air ducts 18 are also arranged parallel to one another in the height direction H as well as on top of or next to one another, respectively. The air ducts 16 are thereby in each case provided between two coolant ducts 17, which are adjacent to one another in the height direction H. In the height direction H, air ducts 16 and coolant ducts 17 thus alternate with one another.

As can be seen, the air ducts 16 extend continuously from the air inlet side 20 to the air outlet side 21 through the heat exchanger block 15. Each individual air duct 16 has a duct height 28, measured in the height direction H, which is constant along the depth direction T. The duct height 28 in the first heat exchanger stage 18 is thus the same as in the second heat exchanger stage 19.

In the first heat exchanger stage 18, air duct 16 and coolant duct 17 alternate directly and indirectly in the height direction H, so that a coolant duct 17 is in each case arranged between two air ducts 16, which are adjacent in the height direction H. In the second heat exchanger stage 19, an arrangement 29, which in each case consists of two thermoelectric modules 22 and a coolant duct 17, is arranged between two air ducts 16, which are adjacent in the height direction H. In the height direction H, the coolant duct 17 is thereby arranged between the two thermoelectric modules 22 within the respective arrangement 29. The respective arrangement 29 has an arrangement height 30, which is measured in the height direction H. The arrangement height 30 is identical to a duct height 31, which is also measured in the height direction H and which belongs to that coolant duct 17, which is adjacent thereto in the first heat exchanger stage 18 in the depth direction T. A constant outer dimension can thus also be ensured across both heat exchanger stage 18, 19 during operation of the coolant ducts 17 along the depth direction T, which simplifies a constant duct height 28 for the adjacent air ducts 16.

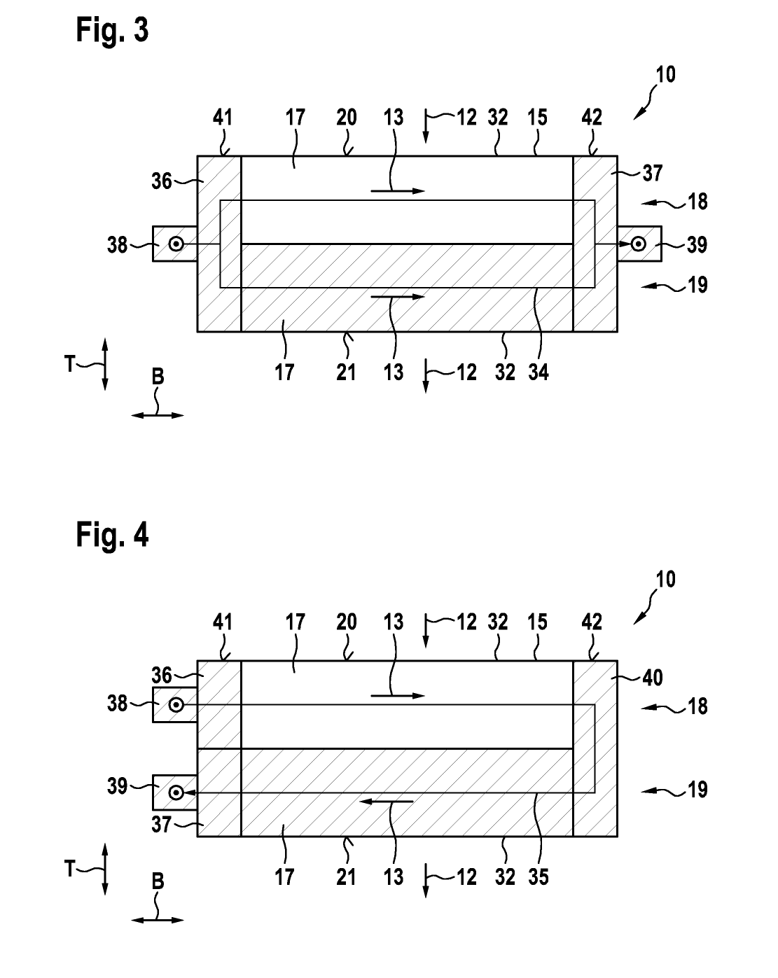

In the simplified embodiments shown here, the coolant ducts 17 and the air ducts 16 in each case extend straight and parallel to one another. The coolant ducts 17 can advantageously be formed by coolant pipes 32, which guide the coolant flow 13 and which run in the heat exchanger block 15. The coolant pipes 32 can also extend parallel to the width direction B, which can be gathered from the sectional views of FIGS. 3 and 4. Turbulators, which are not shown here, can be arranged in the coolant ducts 16 in the usual way to improve the heat transfer.

To realize the air ducts 16, no separate pipe bodies are required on principle. Only end plates 33 can be provided on the ends of the heat exchanger block 15, which are spaced apart from one another in the height direction H, to limit the respective last or outermost air duct 16 at that location. Moreover, the air ducts 16 within the first heat exchanger stage 18 are limited by the coolant pipes 17 and within the second heat exchanger stage 19 by the thermoelectric modules 22. Turbulators or lamellae can be arranged in the usual way in the air ducts 16 to improve the heat transfer. The thermoelectric modules 22 can in particular be equipped with cooling ribs on their outer sides, which are subjected to the air flow 12, to improve the heat transfer.

In the embodiment shown in FIG. 3, the coolant ducts 17 are fluidically connected to one another in such a way in the heat exchanger block 15 that the coolant flow 13 flows parallel through the coolant ducts 17, which run in the first heat exchanger stage 18, and through the coolant ducts 17, which run in the second heat exchanger stage 19. This parallel connection is identified with 34 in FIG. 3. In contrast thereto, FIG. 4 shows an embodiment, in which a series connection or connection in series 35, respectively, is realized. In other words, the coolant ducts 17 are fluidically connected to one another in the heat exchanger block 15 in such a way that the coolant flow 13 flows through the coolant ducts 17, which run in the first heat exchanger stage 18, and through the coolant ducts 17, which run in the second heat exchanger stage 19, in series, thus in succession.

In both examples of FIGS. 3 and 4, the coolant flows through the coolant ducts 17 in the first heat exchanger stage 18 in parallel. The coolant likewise flows through the coolant ducts 17 within the second heat exchanger stage 19 in parallel. In the case of the parallel connection 34 according to FIG. 3, the coolant ducts 17 are flown through in the first heat exchanger stage 18 and in the second heat exchanger stage 19 in the same direction. In contrast, coolant flows through the coolant ducts 17 of the first heat exchanger stage 18 and of the second exchanger stage 19 in opposite direction, in the case of the series connection 35 according to FIG. 4.

In the embodiment shown in FIG. 3, the parallel connection is reached with the help of a distributor box 36, which is provided on the heat exchanger block 15 jointly for both heat exchanger stages 18, 19. Provision is furthermore made for a joint header box 37 on the heat exchanger block 15, which is also assigned to both heat exchanger stages 18, 19. Distributor box 36 and header box 37 are arranged on sides 41, 42 of the heat exchanger block 15, which face away from one another, with respect to the width direction B. Distributor box 36 and header box 37 are further fluidically connected to one another via the coolant ducts 17 or the coolant pipes 33, respectively. The distributor box 36 has a coolant inlet 38. In contrast, the header box has a coolant outlet 39.

In the embodiment shown in FIG. 4, the series connection 35 is also realized with the help of a distributor box 36, which has the coolant inlet 38, and a header box 37, which has the coolant outlet 39, in connection with a deflection box 40. The distributor box 36 is thereby arranged on the one or first side 41 of the heat exchanger block 15 and is thereby only assigned to one of the heat exchanger stages 18, 19, here to the first heat exchanger stage 18. The header box 37 is also arranged on the first side 41 of the heat exchanger block 15 and is assigned to the respective other, here to the second heat exchanger stage 19. The deflection box 40 is arranged on the other or second side 42 of the heat exchanger block 15, which is located opposite to or faces away from, respectively, the first side 41 in the width direction B. The deflection box 40 is assigned to both heat exchanger stages 18, 19. The deflection box 40 is thus fluidically connected to the distributor box 36 via the coolant ducts 17, which run in the first heat exchanger stage 18, while it is fluidically connected to the header box 37 via the coolant ducts 17, which run in the second heat exchanger stage 19. In the example of FIG. 4, the air ducts 16 and the coolant ducts 17 are arranged within the heat exchanger block 15 in such a way that a flow-through according to the cross co-flow principle sets in. The coolant thus flows through the first heat exchanger stage 18 first and then through the second heat exchanger stage 19. An arrangement according to the cross-counter flow principle, however, is conceivable as well.

1. A heat exchanger for heating a vehicle interior comprising:
a heat exchanger block including a plurality of air ducts through which an air flow is flowable in parallel, and a plurality of coolant ducts through which a coolant flow is flowable, the plurality of air ducts and the plurality of coolant ducts coupled to one another in a heat-transferring and media-separated manner;
the plurality of air ducts and the plurality of coolant ducts arranged in the heat exchanger block according to a cross flow principle;
the heat exchanger block having a first heat exchanger stage and a second heat exchanger stage, the first heat exchanger stage including an air inlet side of the heat exchanger block and the second heat exchanger stage including an air outlet side of the heat exchanger block;
wherein the plurality of air ducts and the plurality of coolant ducts extend through the first heat exchanger stage and through the second heat exchanger stage such that the plurality of air ducts and the plurality of coolant ducts are coupled to one another in a heat-transferring and media-separated manner in the first heat exchanger stage and in the second heat exchanger stage; and
wherein a plurality of thermoelectric modules, configured to operate as a heat pump to transfer heat from the coolant flow to the air flow, are arranged between the plurality of air ducts and the plurality of coolant ducts only in the second heat exchanger stage.

2. The heat exchanger according to claim 1, wherein:
the first heat exchanger stage and the second heat exchanger stage adjoin one another in a depth direction of the heat exchanger block;
at least two coolant ducts of the plurality of coolant ducts extend parallel to one another in the heat exchanger block and are arranged next to one another in the depth direction;
a subset of coolant ducts of the plurality of coolant ducts extend parallel to one another in the heat exchanger block and are arranged next to one another in a height direction of the heat exchanger block, the height direction extending perpendicular to the depth direction; and
the plurality of air ducts and the plurality of coolant ducts are arranged in an alternating manner in the height direction.

3. The heat exchanger according to claim 2, wherein:
the plurality of air ducts extend continuously from the air inlet side to the air outlet side; and
each of the plurality of air ducts has a duct height in the height direction that is at least one of i) substantially constant along the depth direction and ii) approximately the same in the first heat exchanger stage as in the second heat exchanger stage.

4. The heat exchanger according to claim 2, wherein an arrangement including at least one thermoelectric module of the plurality of thermoelectric modules and a coolant duct of the plurality of coolant ducts is arranged in the second heat exchanger stage between two air ducts of the plurality of air ducts, the two air ducts arranged adjacent to one another in the height direction.

5. The heat exchanger according to claim 4, wherein the arrangement includes only one thermoelectric module of the plurality of thermoelectric modules.

6. The heat exchanger according to claim 4, wherein the arrangement includes two thermoelectric modules of the plurality of thermoelectric modules, and wherein the coolant duct is arranged between the two thermoelectric modules relative to the height direction.

7. The heat exchanger according to claim 4, wherein the arrangement has an arrangement height in the height direction larger than a duct height, in the height direction, of an adjacent coolant duct of the plurality of cooling ducts, the adjacent coolant duct extending in the first heat exchanger stage and arranged adjacent to the arrangement in the depth direction.

8. The heat exchanger according to claim 2, wherein the plurality of coolant ducts extend substantially straight and parallel to one another as well as parallel to a width direction of the heat exchanger block, the width direction extending perpendicular to the height direction and perpendicular to the depth direction.

9. The heat exchanger according to claim 2, wherein the plurality of coolant ducts are structured as a plurality of coolant pipes extending in the heat exchanger block and configured to guide the coolant flow.

10. The heat exchanger according to claim 9, wherein the plurality of air ducts are limited by the plurality of coolant pipes in the first heat exchanger stage and by at least one of the plurality of thermoelectric modules in the second heat exchanger stage.

11. The heat exchanger according to claim 2, wherein the plurality of coolant ducts are fluidically connected to one another such that the coolant flow is flowable through the plurality of coolant ducts in the first heat exchanger stage and the second heat exchanger stage in parallel.

12. The heat exchanger according to claim 11, further comprising:
a distributor box shared by the first heat exchanger stage and the second heat exchanger stage, the distributor box including a coolant inlet; and
a header box shared by the first heat exchanger stage and the second heat exchanger stage, the header box including a coolant outlet;
wherein the distributor box and the header box are arranged on opposite sides of the heat exchanger block facing away from one another in a width direction of the heat exchanger block and are fluidically connected to one another via the plurality of coolant ducts; and
wherein the width direction extends perpendicular to the height direction and perpendicular to the depth direction.

13. The heat exchanger according to claim 2, wherein the plurality of coolant ducts are fluidically connected to one another such that the coolant flow is flowable through the plurality of coolant ducts in the first heat exchanger stage and the second heat exchanger stage in series.

14. The heat exchanger according to claim 13, further comprising:
a distributor box associated with one of the first heat exchanger stage and the second heat exchanger stage, the distributor box including a coolant inlet;
a header box associated with the other of the first heat exchanger stage and the second heat exchanger stage, the header box including a coolant outlet; and
a deflection box fluidically connected to the distributor box and to the header box via the plurality of coolant ducts;
wherein the distributor box and the header box are arranged on a first side of the head exchanger block and the deflection block is arranged on a second side of the heat exchanger block facing away from the first side in a width direction of the heat exchanger block, the width direction extending perpendicular to the height direction and perpendicular to the depth direction.

15. The heat exchanger according to claim 13, wherein the plurality of coolant ducts and the plurality of air ducts are arranged in the heat exchanger block according to a cross co-flow principle.

16. A vehicle having one of an electric drive and a hybrid drive comprising:
a cooling circuit including a coolant and configured to cool at least one component that heats up during operation;
a heat exchanger including:
a heat exchanger block including a plurality of air ducts through which an air flow is flowable in parallel and a plurality of coolant ducts through which a coolant flow is flowable, the plurality of air ducts and the plurality of coolant ducts coupled to one another in a heat-transferring and media-separated manner and arranged in the heat exchanger block according to a cross flow principle, the heat exchanger block having a first heat exchanger stage and a second heat exchanger stage, the first heat exchanger stage including an air inlet side of the heat exchanger block and the second heat exchanger stage including an air outlet side of the heat exchanger block, the plurality of air ducts and the plurality of coolant ducts extending through the first heat exchanger stage and the second heat exchanger stage such that the plurality of air ducts and the plurality of coolant ducts are coupled to one another in a heat-transferring and media-separated manner in both the first heat exchanger stage and the second heat exchanger stage; and
a plurality of thermoelectric modules arranged in the second heat exchanger stage between the plurality of air ducts and the plurality of coolant ducts, the plurality of thermoelectric modules configured to operate as a heat pump to transfer heat from the coolant flow to the air flow;
a fan configured to provide the air flow, the air flow guidable through the plurality of air ducts of the heat exchanger and into a vehicle interior; and
a control device configured to control the plurality of thermoelectric modules of the heat exchanger;
wherein the heat exchanger is integrated into the cooling circuit such that the cooling circuit provides the coolant flow to the heat exchanger; and
wherein the control device is configured to adjust a strength of the plurality of thermoelectric modules to heat the air flow based on a temperature of the coolant and a setpoint-actual deviation of a temperature for the vehicle interior.

17. The vehicle according to claim 16, wherein:
the first heat exchanger stage and the second heat exchanger stage adjoin one another in a depth direction of the heat exchanger block;
at least two coolant ducts of the plurality of coolant ducts extend parallel to one another in the heat exchanger block and are arranged next to one another in the depth direction;
a subset of coolant ducts of the plurality of coolant ducts extend parallel to one another in the heat exchanger block and are arranged next to one another in a height direction of the heat exchanger block, the height direction extending perpendicular to the depth direction; and
the plurality of air ducts and the plurality of coolant ducts are arranged in an alternating manner in the height direction.

18. The vehicle according to claim 17, wherein the plurality of coolant ducts are fluidically connected to one another such that the coolant flow is flowable through the plurality of coolant ducts in the first heat exchanger stage and the second heat exchanger stage in parallel.

19. The vehicle according to claim 17, wherein the plurality of coolant ducts are fluidically connected to one another such that the coolant flow is flowable through the plurality of coolant ducts in the first heat exchanger stage and the second heat exchanger stage in series.

20. A heat exchanger comprising:
a heat exchanger block defining a depth direction, a height direction extending perpendicular to the depth direction, and a width direction extending perpendicular to both the depth direction and the height direction, the heat exchanger having a first heat exchanger stage and a second heat exchanger stage adjoining the first heat exchanger stage in the depth direction, the first heat exchanger stage including an air inlet side of the heat exchanger block, and the second heat exchanger stage including an air outlet side of the heat exchanger block;
a plurality of air ducts through which an air flow is flowable in parallel, the plurality of air ducts arranged within the heat exchanger block and extending continuously from the air inlet side to the air outlet side, each of the plurality of air ducts having a duct height in the height direction that is at least one of i) substantially constant along the depth direction and ii) approximately the same in the first heat exchanger stage and the second heat exchanger stage;
a plurality of coolant ducts through which a coolant flow is flowable, the plurality of coolant ducts arranged within the heat exchanger block and extending substantially straight and parallel to one another in the width direction, the plurality of air ducts and the plurality of coolant ducts extending through the first heat exchanger stage and the second heat exchanger stage such that the plurality of air ducts and the plurality of coolant ducts are coupled to one another in a heat-transferring and media-separated manner in both the first heat exchanger stage and the second heat exchanger stage, the plurality of air ducts and the plurality of coolant ducts arranged in an alternating manner in the height direction, at least two coolant ducts of the plurality of coolant ducts extending parallel to one another and arranged next to one another in the depth direction, a subset of coolant ducts of the plurality of coolant ducts extending parallel to one another and arranged next to one another in the height direction; and
a plurality of thermoelectric modules arranged in the second heat exchanger stage between the plurality of air ducts and the plurality of coolant ducts, the plurality of thermoelectric modules configured to operate as a heat pump to transfer heat from the coolant flow to the air flow;
wherein the plurality of air ducts and the plurality of coolant ducts are arranged in the heat exchanger block according to a cross flow principle.
